(19) United States
(12) Patent Application Publication
(10) Pub. No.: US 2009/0206155 A1
(43) Pub. Date: Aug. 20, 2009

(54) Novel Coin Exchange system and method

(76) Inventor: Michael J. Chen, Tustin, CA (US)

Correspondence Address: AGNEW INTERNATIONAL;PATENT & TRADEMARK LAW FIRM, 7700 Irvine Center Drive, SUITE 800, Irvine, CA, 92618, US

(21) Appl. No.: 12/054,879

(22) Filed: Mar. 25, 2008

Related U.S. Application Data
(60) Provisional application No. 61/029,540, filed on Feb. 18, 2008.

(51) Int. Cl. G06Q 40/00

(52) U.S. Cl. 235/379

(57) ABSTRACT

A method and a system of exchanging coins, comprising determining an amount of coins to be dispensed in a sales transaction; transmitting the amount to a card reader terminal; retrieving account identification data from a card wherein the card stores account identification data; transmitting the amount and the account identification data to a central computer; redeeming, by an user at a later time, the amount less a fee in an user's preferred method.

### CROSS REFERENCE TO RELATED APPLICATION

This application claims the benefit of priority under 35 U.S.C. 119(e) to the filing date of U.S. provisional patent application No. 61/029,540 entitled “Novel Coin Exchange System and Method” which was filed Feb. 18, 2008, and is incorporated herein by reference.

### FIELD OF THE INVENTION

The present invention relates generally to method and system of coin exchange, and more specifically to a method and a system of coin exchange whereby the coins are eliminated during sales transactions.

### BACKGROUND OF THE INVENTION

Today, there are a variety of machines and methods that exchanges coins. They typically dispense stamps, tickets, coupons, money orders, and even conduct bank transaction.

One type of the machine disclosed in U.S. Pat. No. 5,039,848, issued to Raymond Stoken, dispenses coupons in exchange for money. A display area indicates the different coupons available as well as the specific amount of money required to obtain each particular coupon. Money is inserted into the machine via a coin slot. Control circuitry determines which coupon has been selected, the amount of money required to purchase this coupon, and if the correct amount of money has been inserted into the coin slot. The control circuitry then causes the coupon dispenser to dispense the requested coupon.

On the other hand, U.S. Pat. No. 5,021,967 to Lawrence Smith is a money order dispensing machine. This machine is meant to be operated by a system operator, not a customer, and therefore does not require the capability to receive money. The machine prints money orders on a dot matrix printer after receiving the necessary data inputs from the operator.

These devices are deficient from the point of view of a consumer with an arbitrary amount of coins, since they require the input of an exact coin value.

Other machines which sort coins have also been patented. One such machine, is shown in U.S. Pat. No. 4,995,848 which uses two methods to sort coins, both methods based on the diameter of the coins. Another type of machine shown in U.S. Pat. No. 4,059,122, issued to Yoshio Kinoshita, counts the number of coins according to denomination after sorting the coins.

These system and methods are intended for counting and sorting coins and does not transfer the value from the medium of coins to a more convenient form such as a paper form.

Yet another machine disclosed in U.S. Pat. No. 5,564,546 is capable of receiving an arbitrary amount of coins which does not require insertion of an exact minimum amount and which converts the value of the coin from the inconvenient medium of coins to a more convenient paper medium. Despite the improvement of this machine over the previous machines, the coin exchange system still involves the inconvenience of paper medium.

Thus, it would be advantageous to provide a system and method capable of receiving an arbitrary amount of coins, which does not require insertion of an exact minimum amount, which completely eliminates the need to use paper medium, and which converts the value of the coin from the inconvenient medium of coins to a more convenient medium of a card with magnetic stripe or a card with IC chip where the system is managed by a remote host.

### OBJECT OF THE INVENTION

It is an object of the invention to provide a system and method that would eliminate the majority of the needs to circulate coins, whereby hundreds and thousands of tons of raw metal materials can be reallocated for different purposes, saving precious earth resources and reduce unnecessary social costs.

It is an object of this invention to provide a coin exchange system and method capable of receiving an arbitrary amount of coins.

It is an object of this invention to provide a coin exchange system and method which does not require insertion of an exact minimum amount.

It is an object of this invention to provide a coin exchange system and method which completely eliminates the need to use paper medium.

It is an object of this invention to provide a coin exchange system and method which converts the value of the coin from the inconvenient medium of coins to a more convenient medium of a card with magnetic stripe or a card with IC chip where the system is managed by a remote host.

It is an additional object to provide a coin exchange system and method that works with existing cashier machines.

### SUMMARY OF INVENTION

The present invention discloses a method of exchanging coins, comprising determining, by a cashier machine, an amount of coins to be dispensed in a sales transaction, wherein the cashier machine is positioned in a retail store; transmitting, by the cashier machine, the amount to a card reader terminal, wherein the card reader terminal is operably linked to the cashier machine; retrieving, by the card reader, account identification data from a card wherein the card stores account identification data; transmitting, by the card reader terminal, the amount and the account identification data to a central computer, wherein the central computer is operated by a host, wherein the central computer is located remotely from the retail store and wherein the card reader terminal is communicately coupled to the central computer; redeeming, by an user at a later time, the amount less a fee in an user's preferred method.

In one embodiment, the card is a magnetic stripe card. In another embodiment, the card is a smart card. In yet another embodiment, the card reader terminal retrieves account identification data from the card using radio frequency identification technology. Where the card is a smart card, the card reader terminal is also capable of transmitting the amount to the card. In yet another embodiment, the card reader terminal transmits account to the amount to the card using radio frequency identification technology. In yet one embodiment, the card reader terminal transmits the account identification data to a central computer intermittently.

In one aspect, the user retrieves the amount less a fee in currency from a bank. In another aspect, the user redeems the amount less a fee by exchanging for a product in a store. In anther aspect, the store is an online store.

In yet another aspect, the preferred method is donating, by the user, the amount less a fee to a charity. In another aspect, the preferred method is making purchases with, by the user, the amount less a fee from a point of sale system. In yet one other aspect, the preferred method is depositing, by the host, the amount less a fee to a bank account of user's choice.

In another embodiment, a coin exchange system comprising: a central computer; a cashier machine positioned in a retail store, wherein the retail store is located remotely from the central computer; a card, wherein the card stores account identification data; a card reader terminal operably linked to the cashier machine and communicately linked to the central computer, wherein the card reader terminal retrieves the personal identification data and transmits the personal identification data to the central computer, wherein the cashier machine determines an amount of coins to be dispensed in a sales transaction and transmits the amount to the card reader terminal, wherein the card reader terminal transmits the amount to the central computer, wherein the central computer stores the amount and the personal identification data, wherein an user redeems the amount at a later time in an user's preferred method.

In one aspect, the card is a magnetic stripe card. In another aspect, the card is a smart card. Where the card is a smart card, the card reader terminal retrieves account identification data from the card using radio frequency identification technology.

In yet another embodiment, the card reader terminal is able to transmit the amount to the card. In yet another embodiment, the card reader terminal transmits account to the amount to the card using radio frequency identification technology. In one aspect, the preferred method is retrieving, by the user, the amount less a fee in currency from a bank. In another aspect, the preferred method is redeeming, by the user, the amount less a fee by exchanging for a product in a store. In yet another aspect, the store is an online store. In yet another aspect, the preferred method is donating, by the user, the amount less a fee to a charity. In yet another aspect, the preferred method is making purchases with, by the user, the amount less a fee from a point of sale system. In yet another aspect, the preferred method is depositing, by the host, the amount less a fee to a bank account of user's choice. In yet another aspect, the central computer is located at a host.

### BRIEF DESCRIPTION OF THE DRAWING

FIG. 1 is a system diagram of an embodiment of the coin exchange system in a typical environment where the card contains magnetic stripe.

FIG. 2 is a flow chart of how an embodiment of the coin exchange system functions where the card contains magnetic stripe.

FIG. 3 is a system diagram of an embodiment of the coin exchange system in a typical environment where the card is a smart card.

FIG. 4. is a flow chart of how an embodiment of the coin exchange system functions where the card is a smart card.

FIG. 5 is a system diagram of an embodiment of the coin exchange system in a typical environment where the card is a smart card and where the POS, the kiosk, and the card reader terminal are not linked to the host and the central computer for every transaction.

FIG. 6 is a flow chart of how an embodiment of the coin exchange system functions where the card is a smart card and where the POS, the kiosk, and the card reader terminal are not linked to the host and the central computer for every transaction.

### DETAIL DESCRIPTION OF THE INVENTION

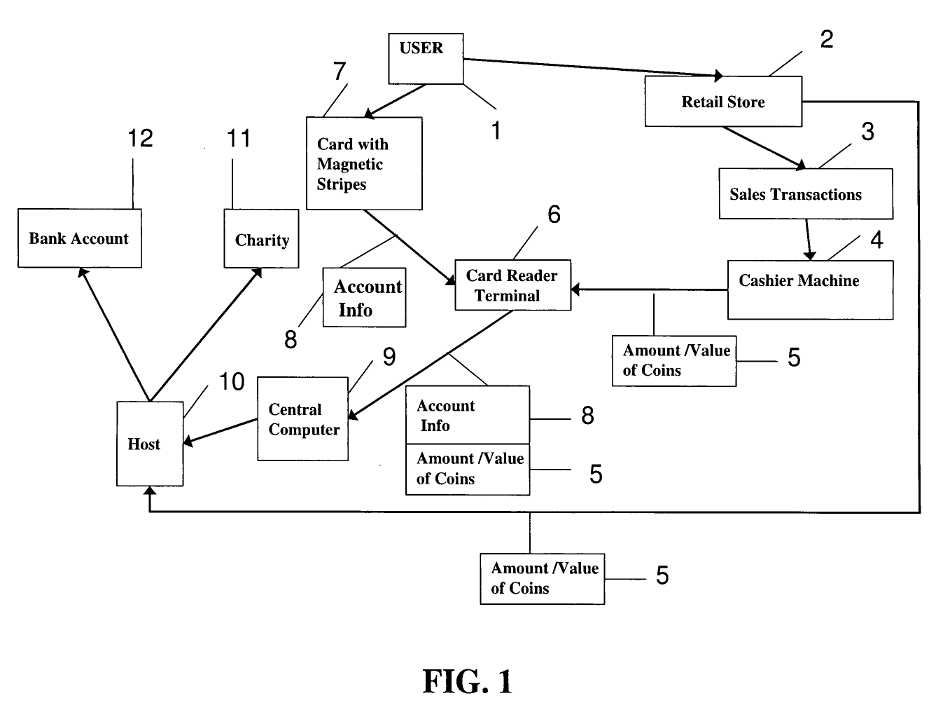

Reference is now made to FIG. 1, which illustrates a coin exchange system comprising a card, a user, a cashier machine, a card reader terminal, a central computer and a host. In FIG. 1, the diagram discloses a typical embodiment on the present invention. In this depiction, the user enters a retail store 2 and makes a typical sales transaction 3. The retail store 2 can be a supermarket, a post office, a shop in the mall or any store that engages retail transactions. Where the user uses cash to make the purchases, it is inevitable that changes in coins will be provided. As the cashier machine 4 makes a determination of the amount of changes in coins 5 to give to the user, the machine is operably coupled to the card reader terminal 6 and transmits the value of the amount of coins 5 to be given, instead of dispensing the coins, to the card reader terminal 6. Then the user swipes the card with magnetic stripe 7 through the card reader terminal 6 and the card reader terminal 6 then retrieves account information 8 from the card 7. Typical account information 8 would be the account number, name of the account holder, and the likes. The card reader terminal 6 then transmits the account information 8 and the value of the amount of coins 5 to be credited to the account to the central computer 9 where the central computer 9 then stores the information. Each time the user enters a sales transaction 3, the value of the amount of coins 5 to be credited are transmitted from the card reader 6 to the central computer 9 and the central computer 9 keeps a tabulation of the total value of amount of coins in connection to each individual account. The central computer 9 is operated by a host 10 and at the choice of the users 1, the host 10 disburses the amount 5 less a fee to a bank account 12 of the choice by the user, to a charity 11 of the choice by the user.

The host then collects the original amount 5 from the retail stores 2. In one embodiment, the card reader terminal 6 of the present invention is able to work with today's cashier machine in supermarket that works with coin dispenser. The card reader terminal 6 directly replaces the coin dispenser and coupled to the cashier machine 4.

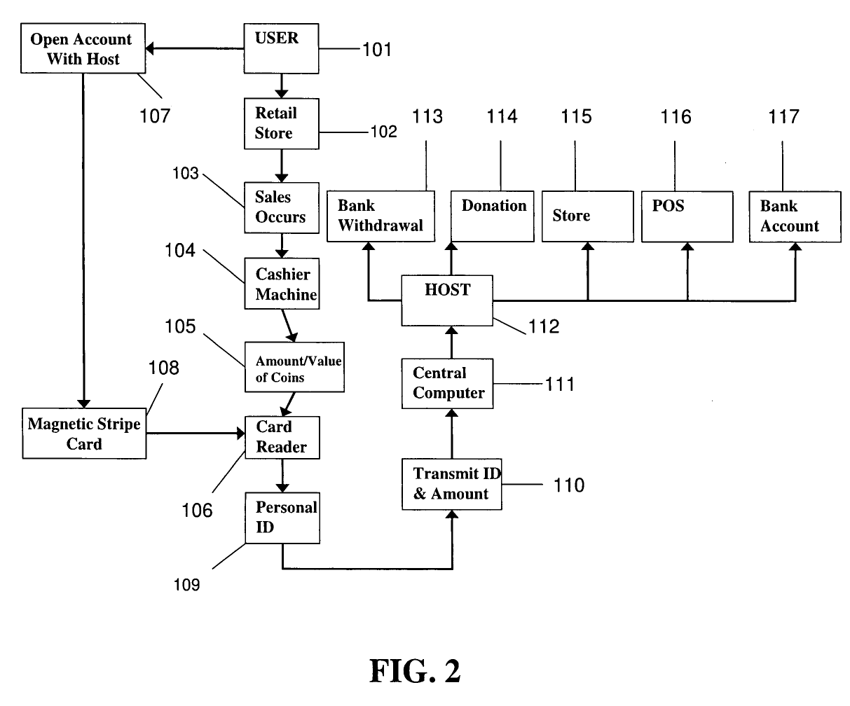

FIG. 2 depicts a flow chart of how an embodiment of present invention functions. An user 101 first opens an account 107 with the host and then the user 101 is issued a card with magnetic stripe 108. The magnetic stripe card 108 contains the account information that associates the user with the account. The user 101 enters a retail store 102 and makes a sales transaction 103. Based on the sales price and the amount of cash tendered, the cashier machine 104 makes a determination of the amount of coins to be dispensed. The cashier machine 104 then transmits the amount of coins 105 to be dispensed to the card reader terminal 106. Then the user 101 swipes the magnetic stripe card 108 through the card reader 106 and the card reader 106 then retrieves the account identification data 109 from the card. With the account identification data 109 and the value of the amount of coins 105 to be credited to the account, the card reader terminal 106 then transmits the data 109 and the value of the amount to be credited 105 to a central computer 111. Typically the central computer 111 is located remotely from the retail store 102 and the card reader terminal 106 is communicately coupled to the central computer 111, preferably over the internet network. The central computer 111 stores the data associated with the personal ID 109 and the value of the amount of coins to be credited 105. Each time a new sales transaction occurs 103, the process is repeated and a new value of the amount of coins to be credited 105 is added to the user's account. The central computer 111 is managed by a host 112. Depending of the user's 101 preferred method, the host can allow the user to redeem the money in the account in a bank withdraw 113. Similarly, the user 101 can ask the host 112 to transfer the money in the account to a charity 114. Likewise, the user 101 can use the money to make purchases from a store 115 or more preferably an online store. Further, the user 101 can redeem the money by making purchases from a point of sales of system 116. Likewise, the user 101 can have the host 112 to transfer the money to a bank account 117 of user's preference.

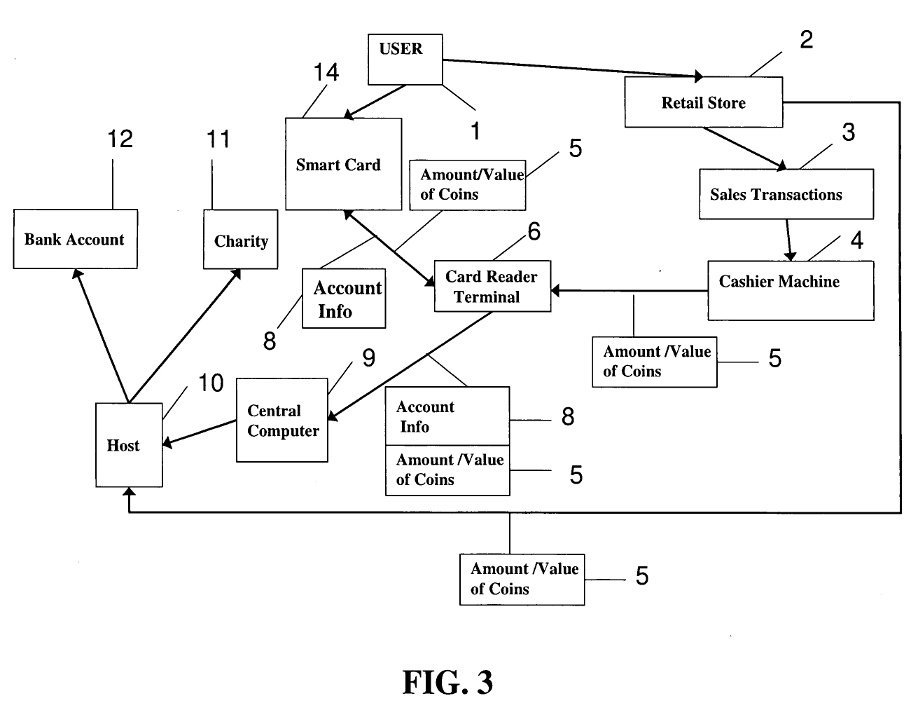

Now referring to FIG. 3, this diagram depicts an embodiment of coin exchange system where the card now is a smart card. A smart card, or integrated circuit card (ICC), is defined as any pocket-sized card with embedded integrated circuits which can process information. This implies that it can receive input which is processed—by way of the ICC applications—and delivered as an output.

Specifically, FIG. 3 illustrates a coin exchange system comprising a smart card 14, a user 1, a cashier machine 4, a card reader terminal 6, a central computer 9 and a host 10. In FIG. 3, the diagram discloses a typical embodiment on the present invention. In this depiction, the user 1 enters a retail store 2 and makes a typical sales transaction 3. The retail 2 store can be a supermarket, a post office, a shop in the mall or any stores that engages retail transactions. Where the user 1 uses cash to make the purchases, changes in coins is resulted. The cashier machine 4, which is operably coupled to the card reader terminal 6, makes a determination of the amount of changes in coins to be dispensed 5 and transmits the value of the amount 5, instead of dispensing the coins, to the card reader terminal 6. Then the user 1 can enter the smart card 14 into the card reader terminal 6 and the card reader terminal 6 is then able to retrieve account information 8 from the card 14. In a preferred method, the card is a contact less smart card. A smart card, or integrated circuit card (ICC), is defined as any pocket-sized card with embedded integrated circuits which can process information. This implies that it can receive input which is processed—by way of the ICC applications—and delivered as an output. In this embodiment, the card reader 6 can retrieve the account data 8 without the need to contact the smart card 14. As for the data 8, the typical account information would be the account number, name of the account holder, and the likes. The card reader terminal 6 then transmits the account information 8 and the value of amount of coins 5 to be credited to the central computer 9 where the central computer 9 stores the information. The card reader terminal 6 then transmits the value of the amount to be credited 5 to the smart card 14 where the smart card 14 is able to store the total value of the amount of coins to be credited.

Each time the user enters a sales transaction 3, the value of the amounts of coins 5 to be credited are transmitted from the card reader 6 to the central computer 9 and the central computer 9 credits the value to the account holder. Likewise, where each time an user 1 enters a sales transaction 3, the value of the amounts of coins to be credited 5 are transmitted from the card reader terminal 6 to the smart card 14 and the smart card 14 stores the total value of the amount of coins 5 to be credited in the card. The central computer 9 is operated by a host 10 and at the choice of the user 1, the host 10 disburses the amount less a fee to a bank account 12 of the choice by the user, or to a charity 11 of the choice by the user. The host then collects the amount credited to the user from the retail store.

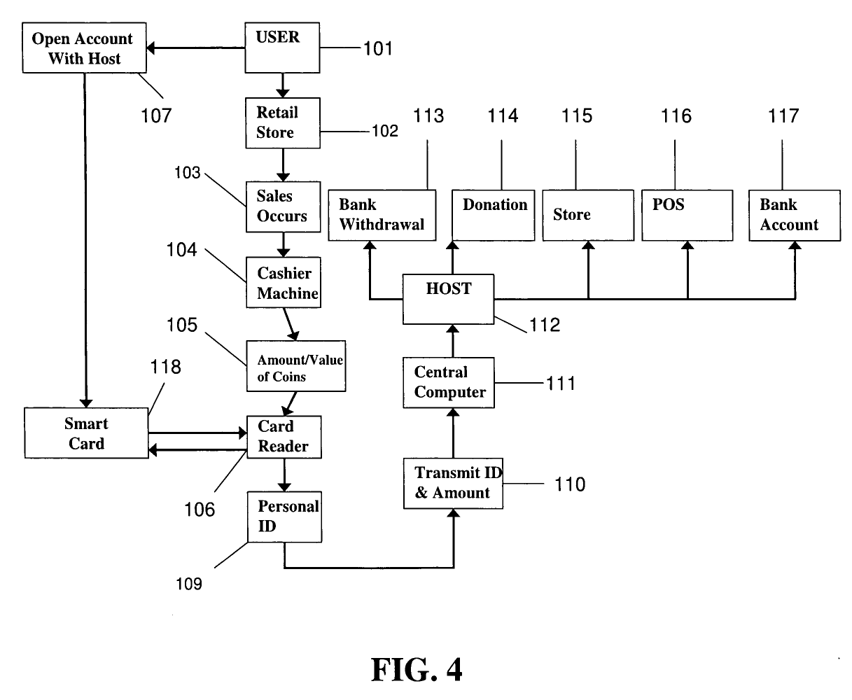

FIG. 4 depicts a flow chart of how the embodiment of FIG. 3 functions. An user 101 opens an account 107 with the host and the user 118 is issued a smart card. The smart card 118 contains the account information 109 that associates the user 101 with the account. The user 101 enters a retail store 102 and makes a sales transaction 103. With the sales occurring, the cashier machine 104 makes a determination of the amount of coins to be dispensed based on the sales price and the amount of cash tendered. The cashier machine 104 then transmits the amount of coins 105 to be dispensed to the card reader terminal 106. Then the user 101 enters the smart card 118 to the card reader 106 and the card reader 106 then retrieves the account identification data 109 from the card 118. Where the smart card 118 is a contact less smart card, the user 101 waives the smart card 118 through the card reader terminal 106 and the card reader is able to pick up the data 109 from the smart card 118. With the account identification data 109 and the value of the amount of coins to be credited to the account 105, the card reader terminal 106 then transmits the personal data 109 and the value 105 to a central computer 111. Further, the card reader terminal 106 then transmits the value of the amount to be credited back to the smart card 118. In this embodiment, the smart card 118 also stores the value of amount of credited coins 105 associated with its account. Typically the central computer 111 is located remotely from the retail store 102 and the card reader terminal 106 is communicately coupled to the central computer 111, preferably over the internet network. The central computer 111 stores the data 109 associated with the personal ID and the value of the amount of coins to be credited 105. Each time a new sales transaction 103 occurs, the process is repeated and a new value is added to the user's account. The addition of money in the account is stored both by the central computer 111 and the smart card 118. The central computer 111 is managed by a host 112. Depending of the user's preferred method, the host 112 allows the user 101 to redeem the money in the account in a bank withdraw 113. Similarly, the user 101 can ask the host 112 to transfer the money in the account to a charity 114. Likewise, the user 101 can use the money to make purchases from a store 115 or more preferably an online store. Further, the user 101 can redeem the money by making purchases from a point of sales of system 116. Likewise, the user 101 can have the host 112 to transfer the money to a bank account 117 of user's preference.

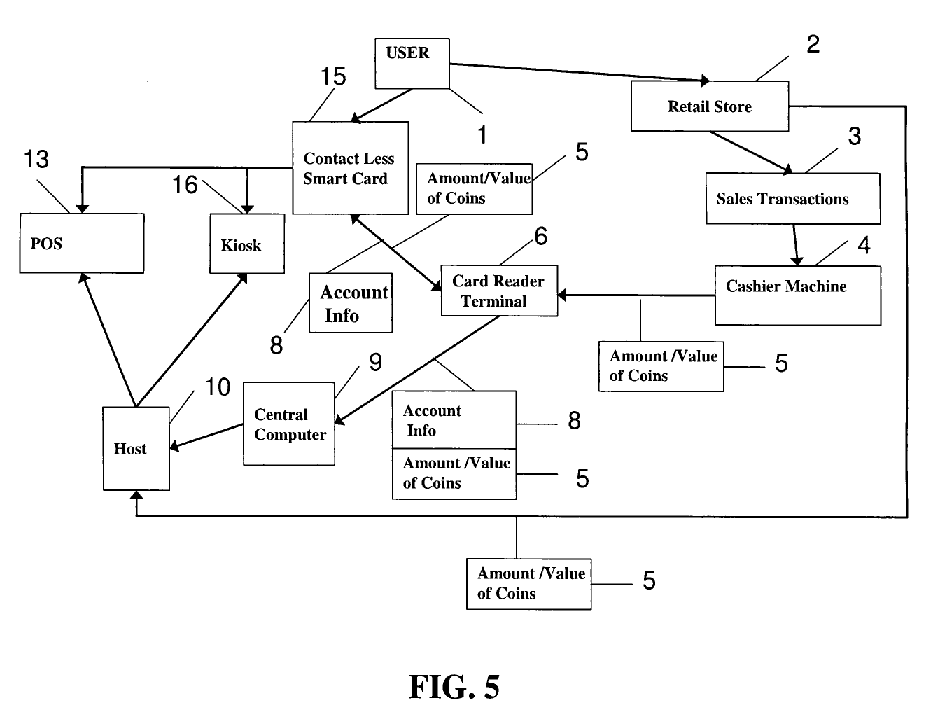

Now referring to FIG. 5, this diagram depicts an embodiment of coin exchange system where the card now is a smart card. This is largely similar to the embodiment of FIG. 3 except that the card reader terminal 6 does not transmit account information 8 and the value of the amount of coins to be credited 5 to the central computer 9 each time a sales occurs 3. Rather, the information is transmitted to the central computer 9 intermittently. The intermittent period can be weekly or monthly. In this embodiment, the smart card 15 keeps track of the value of the amount of coins to be credit 5 to the account. The user 1 can retrieve money from a kiosk 16 or redeem the credit by making purchases from the POS (Point of sales system) 13. The POS 13 or kiosk 16 then reports the transactions back to the host 10. This embodiment is ideal if the card reader terminal 6 is not communicately linked to the central computer 9 on constant basis.

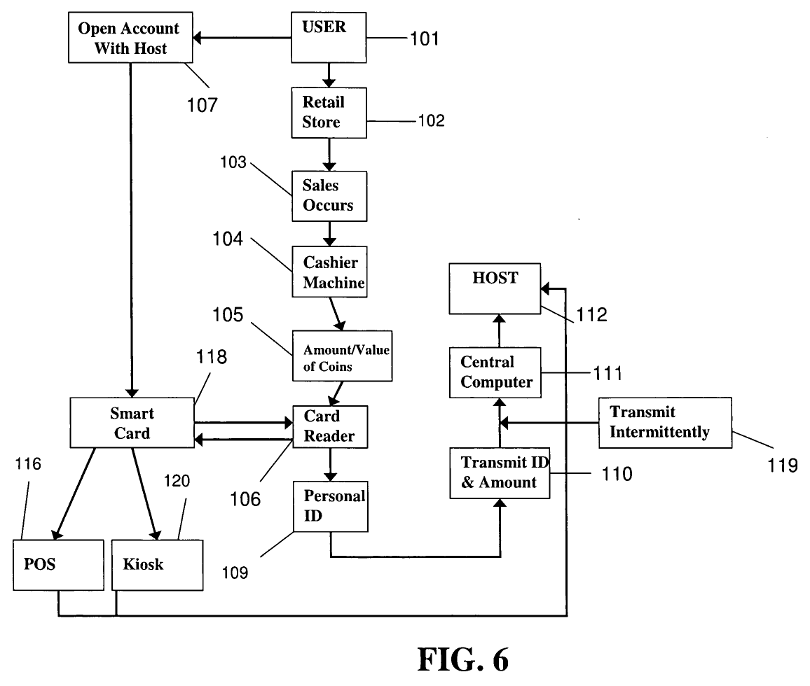

FIG. 6 depicts a flow chart of how the embodiment of FIG. 5 functions. It is similar to the flow char of FIG. 4 except that the information 110 is transmitted to the central computer 111 on intermittently basis 119. In this embodiment, the smart card user 101 retrieves money from the kiosk 120 or redeems the credit by making purchasing from the POS 116.

I claim as follows:

1. A method of exchanging coins, comprising determining, by a cashier machine, an amount of coins to be dispensed in a sales transaction, wherein said cashier machine is positioned in a retail store; transmitting, by said cashier machine, said amount to a card reader terminal, wherein said card reader terminal is operably linked to said cashier machine; retrieving, by said card reader, account identification data from a card wherein said card stores account identification data; transmitting, by said card reader terminal, said amount and said account identification data to a central computer, wherein said central computer is operated by a host, wherein said central computer is located remotely from said retail store and wherein said card reader terminal is communicately coupled to said central computer; redeeming, by an user at a later time, said amount less a fee in an user's preferred method.

2. The method of claim 1, wherein in said card is a magnetic stripe card.

3. The method of claim 1, wherein in said card is a smart card.

4. The method of claim 3 wherein said card reader terminal retrieves account identification data from said card using radio frequency identification technology.

5. The method of claim 3 further comprising said card reader terminal transmitting said amount to said card.

6. The method of claim 5 wherein said card reader terminal transmits account to said amount to said card using radio frequency identification technology.

7. The method of claim 3 wherein said card reader terminal transmits said account identification data to a central computer intermittently.

8. The method of claim 1, wherein in said preferred method is retrieving, by said user, said amount less a fee in currency from a bank.

9. The method of claim 1, wherein in said preferred method is redeeming, by said user, said amount less a fee by exchanging for a product in a store.

10. The method of claim 9, wherein in said store is an online store.

10. The method of claim 1, wherein in said preferred method is donating, by said user, said amount less a fee to a charity.

11. The method of claim 1, wherein in said preferred method is making purchases with, by said user, said amount less a fee from a point of sale system.

12. The method of claim 1, wherein in said preferred method is depositing, by said host, said amount less a fee to a bank account of user's choice.

13. A coin exchange system comprising: a central computer; a cashier machine positioned in a retail store, wherein said retail store is located remotely from said central computer; a card, wherein said card stores account identification data; a card reader terminal operably linked to said cashier machine and communicately linked to said central computer, wherein said card reader terminal retrieves said personal identification data and transmits said personal identification data to said central computer, wherein said cashier machine determines an amount of coins to be dispensed in a sales transaction and transmits said amount to said card reader terminal, wherein said card reader terminal transmits said amount to said central computer, wherein said central computer stores said amount and said personal identification data, wherein an user redeems said amount at a later time in an user's preferred method.

14. The system of claim 13, wherein in said card is a magnetic stripe card.

15. The system of claim 13, wherein in said card is a smart card.

16. The system of claim 15 wherein said card reader terminal retrieves account identification data from said card using radio frequency identification technology.

17. The system of claim 15 further comprising said card reader terminal transmitting said amount to said card.

18. The system of claim 17 wherein said card reader terminal transmits account to said amount to said card using radio frequency identification technology

19. The system of claim 13, wherein said preferred method is retrieving, by said user, said amount less a fee in currency from a bank.

20. The system of claim 13, wherein in said preferred method is redeeming, by said user, said amount less a fee by exchanging for a product in a store.

21. The system, of claim 13, wherein in said store is an online store.

22. The system of claim 13, wherein in said preferred method is donating, by said user, said amount less a fee to a charity.

23. The system of claim 13, wherein in said preferred method is making purchases with, by said user, said amount less a fee from a point of sale system.

24. The system of claim 13, wherein in said preferred method is depositing, by said host, said amount less a fee to a bank account of user's choice.

25. The system of claim 13, wherein said central computer is located at a host.
